(19) United States
(12) Patent Application Publication
(10) Pub. No.: US 2020/0041293 A1
(43) Pub. Date: Feb. 6, 2020

(54) INFORMATION PROCESSING APPARATUS, INFORMATION PROCESSING METHOD AND NON-TRANSITORY STORAGE MEDIUM

(71) Applicant: TOYOTA JIDOSHA KABUSHIKI KAISHA, Toyota-shi (JP)

(72) Inventors: Akihiko NAKANISHI, Nisshin-shi (JP); Daigo FUJII, Tsushima-shi (JP); Makoto TANAKA, Toyota-shi (JP); Kazuki TAKEUCHI, Toyota-shi (JP); Chie KOIKE, Nagoya-shi (JP); Daiki KANEICHI, Nisshin-shi (JP); Tsuyoshi OKADA, Toyota-shi (JP)

(73) Assignee: TOYOTA JIDOSHA KABUSHIKI KAISHA, Toyota-shi (JP)

(21) Appl. No.: 16/521,872

(22) Filed: Jul. 25, 2019

(30) Foreign Application Priority Data
Aug. 3, 2018 (JP) 2018-146775

(51) Int. Cl. G01C 21/34

(52) U.S. Cl. CPC G01C 21/3438; G01C 21/3469; G01C 21/3453

(57) ABSTRACT

An information processing apparatus according to the present disclosure sets, when determining a combination between a driver user who drives a vehicle and fellow passenger users who ride in the vehicle, a route through which the vehicle driven by the driver user can pass from a place of departure to a destination of the driver user, the route being predicted to allow the driver user to arrive at the destination by a date and time desired by the driver user, as a scheduled traveling route. The information processing apparatus then combines the driver user and a fellow passenger user whose getting-in spot and getting-off spot are located on the scheduled traveling route among fellow passenger users desiring to ride in the vehicle.

### CROSS-REFERENCE TO RELATED APPLICATIONS

This application claims the benefit of Japanese Patent Application No. 2018-146775, filed on Aug. 3, 2018, which is hereby incorporated by reference herein in its entirety.

### BACKGROUND

### Technical Field

The present disclosure relates to an information processing apparatus, an information processing method and a non-transitory storage medium.

### Description of the Related Art

Techniques for determining whether or not owners of terminals are sharing the same vehicle based on position information of the respective terminals and calculating environment loads such as CO₂ emission and fuel consumption based on the determination result are known (e.g., see Patent Literature 1).

### CITATION LIST

### Patent Literature

Patent Literature 1: Japanese Patent Application Laid-Open No. 2011-237842

### SUMMARY

In a mode in which a plurality of users share the same vehicle for traveling (ride sharing), if a combination between a driver user who is a user driving the vehicle and fellow passenger users who are users riding in the vehicle is determined carelessly, it may be difficult for the driver user to arrive at a destination by a scheduled arrival date and time.

The present disclosure has been implemented in view of the above-described circumstances, and it is an object of the present disclosure to provide a technique capable of preventing the driver user from arriving at a destination later than a scheduled arrival date and time as much as possible in ride sharing in which a plurality of users share the same vehicle for traveling.

An information processing apparatus according to the present disclosure is an information processing apparatus in a mode in which a plurality of users share the same vehicle, that determines a combination between a driver user who is a user driving the vehicle and fellow passenger users who are users riding in the vehicle. The information processing apparatus is provided with a controller including at least one processor. The controller is configured to execute: setting, as a scheduled traveling route, a route through which the vehicle driven by the driver user can pass from a place of departure to a destination of the driver user, the route being predicted to allow the driver user to arrive at the destination by a date and time desired by the driver user; and combining the driver user and a fellow passenger user whose getting-in spot which is a desired place of getting in the vehicle and whose getting-off spot which is a desired place of getting off the vehicle are located on the scheduled traveling route among fellow passenger users desiring to ride in the vehicle.

Note that the present disclosure can be considered as an information processing method for determining a combination between a driver user who is a user driving a vehicle and fellow passenger users who are users riding in the vehicle in a mode in which a plurality of users share the same vehicle. The information processing method in that case may be adapted to cause a computer to execute: a step of setting, as a scheduled traveling route, a route through which the vehicle driven by the driver user can pass from a place of departure to a destination of the driver user, the route being predicted to allow the driver user to arrive at the destination by a date and time desired by the driver user; and a step of combining the driver user and a fellow passenger user whose getting-in spot which is a desired place of getting in the vehicle and whose getting-off spot which is a desired place of getting off the vehicle are located on the scheduled traveling route among fellow passenger users desiring to ride in the vehicle.

Furthermore, the present disclosure can also be considered as an information processing program for determining a combination between a driver user who is a user driving a vehicle and fellow passenger users who are users riding in the vehicle in a mode in which a plurality of users share the same vehicle or a non-transitory storage medium that stores the information processing program. The information processing program in that case may be adapted to cause a computer to execute: a step of setting, as a scheduled traveling route, a route through which the vehicle driven by the driver user can pass from a place of departure to a destination of the driver user, the route being predicted to allow the driver user to arrive at the destination by a date and time desired by the driver user; and a step of combining the driver user and a fellow passenger user whose getting-in spot which is a desired place of getting in the vehicle and whose getting-off spot which is a desired place of getting off the vehicle are located on the scheduled traveling route among fellow passenger users desiring to ride in the vehicle.

According to the present disclosure, it is possible to prevent the driver user from arriving at a destination later than a scheduled arrival date and time as much as possible in ride sharing in which a plurality of users share the same vehicle for traveling.

### BRIEF DESCRIPTION OF THE DRAWINGS

FIG. 1 is a diagram for describing an overview of ride-sharing;

FIG. 2 is a diagram illustrating a schematic configuration of a ride-sharing system;

FIG. 3 is a diagram illustrating a hardware configuration of a user terminal and a server apparatus;

FIG. 4 is a block diagram illustrating a functional configuration of the server apparatus;

FIG. 5 is a diagram illustrating a configuration example of a traveling schedule information table;

FIG. 6 is a diagram illustrating a configuration example of a movement schedule information table;

FIG. 7 is a diagram illustrating a configuration example of a reservation information table;

FIG. 8 is a diagram illustrating another configuration example of the reservation information table;

FIG. 9 is a diagram illustrating a configuration example of a member information table;

FIG. 10 is a diagram illustrating an example of a method of setting a scheduled traveling route;

FIG. 11 is a flowchart illustrating an overview of a flow of data transmitted/received among respective components of a ride sharing system and a flow of processes carried out by the respective components; and

FIG. 12 is a flowchart illustrating operation of the server apparatus when setting the scheduled traveling route.

### DESCRIPTION OF THE EMBODIMENTS

The present disclosure is an information processing apparatus that determines a combination between a driver user who is a user driving a vehicle and fellow passenger users who are users riding in the vehicle in a mode in which a plurality of users share the same vehicle (ride sharing).

In the above-described ride sharing, when the vehicle driven by the driver user moves from a place of departure to a destination, if a moving distance of the vehicle increases excessively or the vehicle needs to travel through a congested road or the like caused by the vehicle having to go through getting-in spots and getting-off spots of the fellow passenger users, it may be difficult for the driver to arrive at the destination by the scheduled arrival date and time.

In view of such a problem, when determining a combination between the driver user and fellow passenger users riding in the vehicle driven by the driver user, the controller of the information processing apparatus according to the present disclosure sets, as a scheduled traveling route, a route through which the vehicle driven by the driver user can pass from a place of departure to a destination of the driver user, the route being predicted to allow the driver user to arrive at the destination by a date and time desired by the driver user first. Next, the controller combines the driver user and a fellow passenger user whose getting-in spot and whose getting-off spot are located on the scheduled traveling route among fellow passenger users desiring to ride in the vehicle driven by the driver user other than himself/herself. This reduces, as much as possible, the likelihood that the driver user will be unable to arrive at the destination by the scheduled arrival date and time caused by the vehicle driven by the driver user having to go through getting-in spots and getting-off spots of the fellow passenger users. As a result, it is possible to reduce, as much as possible, the likelihood that the driver user may arrive at the destination later than the scheduled arrival date and time.

Note that when setting the above-described scheduled traveling route, the controller may set the scheduled traveling route based on congestion prediction information and/or traffic regulation information in a time zone in which the driver user moves from the place of departure to the destination. For example, the controller may also set a route that will bypass a road predicted to be congested in a time zone in which the driver user moves from the place of departure to the destination or a road subject to traffic regulation in the same time zone as the scheduled traveling route. When the scheduled traveling route is set using such a method, it is possible to more reliably prevent the driver user from arriving at the destination later than the scheduled arrival date and time.

Hereinafter, specific embodiments of the present disclosure will be described based on the accompanying drawings. Dimensions, materials, shapes, and other relative arrangements or the like of components described in the present embodiments are not intended to limit the technical scope of the present disclosure to those embodiments unless specified otherwise.

### EMBODIMENT

An example will be described in the present embodiment where the present disclosure is implemented in a mode in which a plurality of users intended for traveling share the same vehicle (hereinafter referred to as “ride-sharing”). Note that automobiles and trains or the like can be used as vehicles that can be shared among a plurality of users for a traveling purpose. A case will be described in the present embodiment where an automobile is used as an example of such vehicles.

### Overview of Ride-Sharing

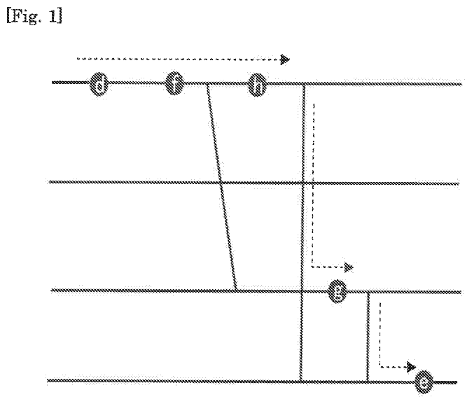

First, an overview of ride-sharing will be described based on FIG. 1. In an example shown in FIG. 1, suppose that a user A travels from the point d to the point e, a user B travels from the point f to the point g and a user C travels from the point h to the point e.

Here, if the users A to C travel separately in their respective vehicles, three vehicles are necessary. In contrast, if the users A to C share the same vehicle, the users A to C can travel to their respective destinations in one vehicle. In the example shown in FIG. 1, the user A himself/herself drives a vehicle and travels from the point d to the point e. At this time, the user A allows the user B to get in the vehicle driven by the user A at the point f, and allows the user C to get in the vehicle driven by the user A at the point h. On the way to the point e which is the destination of the user A and the user C, the user A travels via the point g, where the user B gets off the vehicle, thus allowing the user B to travel from the departure point f to the destination point g. After that, the user A drives the vehicle from the point g to the point e to thereby allow the user C to travel from the point h to the point e, and at the same time the user A himself/herself can attain the traveling of the user A.

Such ride-sharing can reduce the number of vehicles traveling on a road, and can thereby relax traffic jam. Furthermore, since a plurality of users who share the same vehicle share transportation expenses (fuel expenses or the like) necessary for traveling in the vehicle, it is possible to cut down on a transportation cost per user compared to a case where each user travels in an individual vehicle.

Note that the ride sharing mode illustrated in FIG. 1 is merely an example, and a combination of users sharing one vehicle and a traveling route of the vehicle used for ride sharing can be set using various methods. However, if the combination of users sharing the one vehicle is set carelessly, the traveling distance of the vehicle may be increased or the vehicle may have to travel through a congested road or the like. As a result, it may be difficult for the user (driver user) driving the vehicle to arrive at the own destination by the scheduled arrival date and time. Especially when the traveling of the driver user is aimed at commutating to workplace or school or the like, the driver user will not make it in time for attendance time or opening time, and the driver user may thereby suffer disadvantage.

In contrast, in the present embodiment, the server apparatus for performing information processing on operation and management of a ride sharing service sets a route through which the driver user can arrive at the destination by the scheduled arrival date and time as the scheduled traveling route and combines fellow passenger users who are allowed to get in the vehicle without deviating from the scheduled traveling route with the driver user, thus preventing the driver user from arriving at the destination later than the scheduled arrival date and time.

### System Configuration

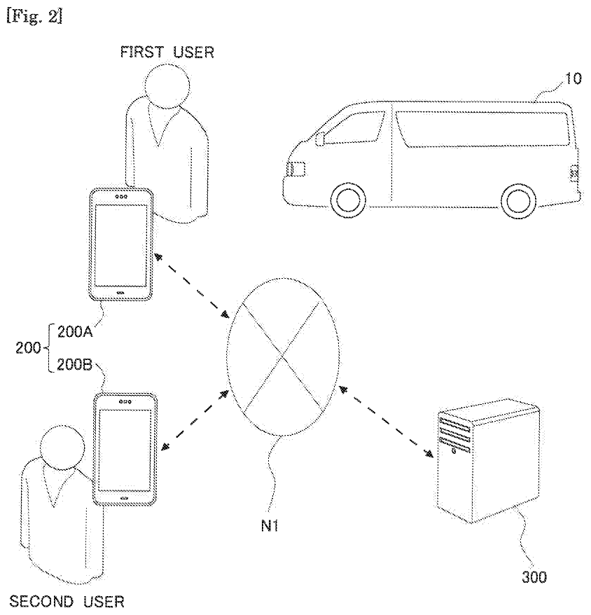

FIG. 2 is a diagram illustrating a configuration example of a system for providing a ride-sharing service (hereinafter may also be referred to as a “ride-sharing system”). In the example shown in FIG. 2, the ride-sharing system is constructed of a vehicle 10 used for ride sharing, a user terminal 200 used by a user sharing the vehicle 10 and a server apparatus 300. The user terminal 200 and the server apparatus 300 are mutually connectable via a network N1. A WAN (Wide Area Network) which is a worldwide public communication network such as the Internet or other communication networks may be adopted for the network N1. The network N1 may include a telephone communication network such as mobile phones or a wireless communication network such as WiFi.

Note that although only one vehicle 10 is illustrated in the example shown in FIG. 2 as the vehicle available for the ride-sharing service, suppose that the ride-sharing system includes a number of vehicles registered as vehicles available for the ride-sharing service. In the example shown in FIG. 2, only two terminals: a first user terminal 200A used by a driver user and a second user terminal 200B used by a fellow passenger user are illustrated, but suppose that the ride-sharing system includes a number of user terminals corresponding to the number of users registered as members entitled to use the ride-sharing service.

A predetermined application for using a ride-sharing service is installed in the user terminal 200. The user of the user terminal 200 causes the own user terminal 200 to execute the above predetermined application, and can thereby register information relating to conditions or the like when sharing a vehicle (hereinafter may also be referred to as “request information”) in the server apparatus 300. For example, the driver user causes the first user terminal 200A to execute the above-described predetermined application, and can thereby register information relating to the own scheduled traveling section of the vehicle 10 and the traveling date and time or the like (traveling schedule) in the server apparatus 300 as request information. The fellow passenger user causes the second user terminal 200B to execute the above-described predetermined application, and can thereby register information relating to the own desired movement section and movement date and time or the like (movement schedule) in the server apparatus 300 as request information.

The server apparatus 300 receives the request information from the driver user and the request information from the fellow passenger user, respectively. The server apparatus 300 determines a provisional combination of a driver user and a fellow passenger user based on the request information from the driver user and the request information from the fellow passenger user. For example, the server apparatus 300 sets a route along which the vehicle 10 driven by the driver user travels from the place of departure to the destination of the driver user (scheduled traveling route) and provisionally combines fellow passenger users whose getting-in spots and getting-off spots are located on the set scheduled traveling route with the driver user. The server apparatus 300 transmits information indicating ride sharing conditions to the user terminals 200 of the driver user and the fellow passenger user in the above provisional combination. When the server apparatus 300 receives information accepting the ride sharing conditions from the respective user terminals 200 of the driver user and the fellow passenger user, the server apparatus 300 confirms the above provisional combination as an official combination. Hereinafter, a process for the server apparatus 300 to confirm a combination of a driver user and a fellow passenger user using the above procedure will be referred to as a “matching process.” Note that the server apparatus 300 having such a function corresponds to the “information processing apparatus” according to the present disclosure.

### Hardware Configuration

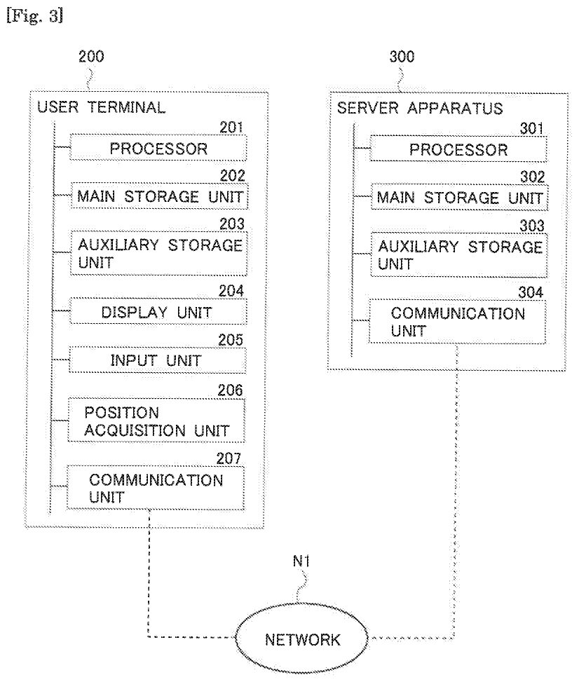

FIG. 3 is a diagram illustrating a hardware configuration of each of the user terminal 200 and the server apparatus 300. Note that the first user terminal 200A and the second user terminal 200B shown in aforementioned FIG. 2 each have a hardware configuration similar to the configuration of the user terminal 200 in FIG. 3.

The server apparatus 300 has a configuration of a general computer. That is, the server apparatus 300 includes a processor 301, a main storage unit 302, an auxiliary storage unit 303 and a communication unit 304. These components are mutually connected via a bus. The main storage unit 302 and the auxiliary storage unit 303 are computer-readable storage media. The hardware configuration of the computer is not limited to the configuration example shown in FIG. 3, but components may be omitted, replaced or added as appropriate.

The server apparatus 300 implements functions matching to a predetermined object by the processor 301 loading a work region of the main storage unit 302 with a program stored in the storage medium and executing the program, and controlling the respective function components through execution of the program.

The processor 301 is, for example, a CPU (Central Processing Unit) or a DSP (Digital Signal Processor). The processor 301 controls the server apparatus 300 and performs operations of various kinds of information processing. The main storage unit 302 includes, for example, a RAM (Random Access Memory) and a ROM (Read Only Memory). The auxiliary storage unit 303 is, for example, an EPROM (Erasable Programmable ROM) or a hard disk drive (HDD). Furthermore, the auxiliary storage unit 303 can include a removable medium, that is, a removable storage medium. The removable medium is a disk storage medium such as a USB (Universal Serial Bus) memory, a CD (Compact Disc) or a DVD (Digital Versatile Disc).

The auxiliary storage unit 303 stores various programs, various kinds of data and various tables in a storage medium in a freely readable/writable state. The auxiliary storage unit 303 stores an operating system (OS), various programs and various tables or the like. Note that a part or a whole of these pieces of information may also be stored in the main storage unit 302. Information stored in the main storage unit 302 may be stored in the auxiliary storage unit 303.

The communication unit 304 transmits/receives information between an external apparatus and the server apparatus 300. The communication unit 304 is, for example, a LAN (Local Area Network) interface board or a wireless communication circuit for wireless communication. The LAN interface board or wireless communication circuit is connected to a network N1.

A series of processes executed by the server apparatus 300 configured as described above may be executed by hardware or may also executed by software.

Next, the user terminal 200 is a small computer that can be carried by the user such as a smartphone, a mobile phone, a tablet terminal, a personal information terminal, a wearable computer (smart watch or the like). Note that the user terminal 200 may also be a personal computer (PC) connected to the server apparatus 300 via the network N1 such as the Internet which is a public communication network.

The user terminal 200 includes a processor 201, a main storage unit 202, an auxiliary storage unit 203, a display unit 204, an input unit 205, a position acquisition unit 206 and a communication unit 207. Since the processor 201, the main storage unit 202 and the auxiliary storage unit 203 are similar to the processor 301, the main storage unit 302 and the auxiliary storage unit 303 of the server apparatus 300, description thereof is omitted. The display unit 204 is, for example, an LCD (Liquid Crystal Display) or an EL (Electroluminescence) panel. The input unit 205 includes, for example, a touch panel that allows symbols such as characters to be inputted, push buttons, a microphone that allows voice to be inputted or a camera that allows a moving image or still image to be picked up. The position acquisition unit 206 is a device that acquires a current position of the user terminal 200 and is typically configured by including a GPS receiver or the like. The communication unit 207 is a communication circuit for accessing the network N1 using, for example, a mobile communication service (telephone communication network such as a mobile phone or wireless communication of WiFi or the like) and carrying out data communication with the server apparatus 300 or the like.

### Functional Configuration of Server Apparatus

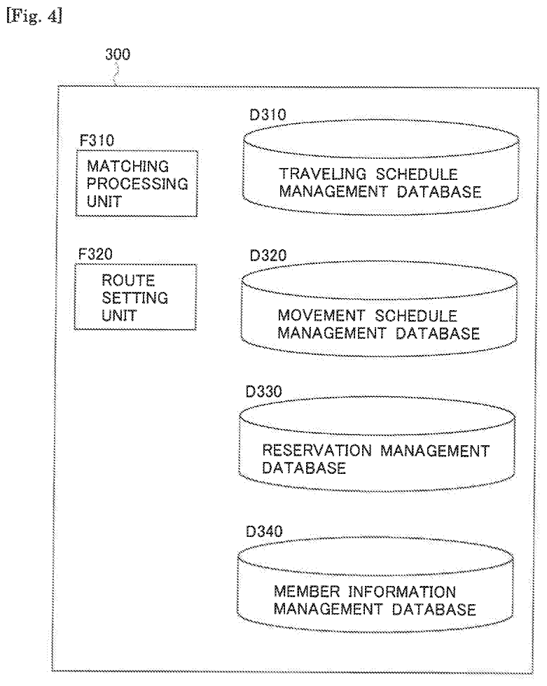

Here, a functional configuration of the server apparatus 300 will be described based on FIG. 4. As shown in FIG. 4, the server apparatus 300 of the present embodiment includes, as functional components thereof, a matching processing unit F310, a route setting unit F320, a traveling schedule management database D310, a movement schedule management database D320 and a reservation management database D330. Here, the matching processing unit F310 and the route setting unit F320 are formed by the processor 301 of the server apparatus 300 executing a computer program in the main storage unit 302. Note that any one or part of the matching processing unit F310 and the route setting unit F320 may be formed of a hardware circuit.

The traveling schedule management database D310, the movement schedule management database D320, the reservation management database D330 and a member information management database D340 are constructed by a program of a database management system (DBMS) executed by the processor 301 of the server apparatus 300 managing data stored in the auxiliary storage unit 303. These traveling schedule management database D310, movement schedule management database D320, reservation management database D330 and member information management database D340 are, for example, relational databases.

Note that any one or part of processing thereof of the respective functional components of the server apparatus 300 may be executed by another computer connected to the network N1. For example, each process included in the matching processing unit F310 and each process included in the privacy processing unit F320 may be executed by different computers.

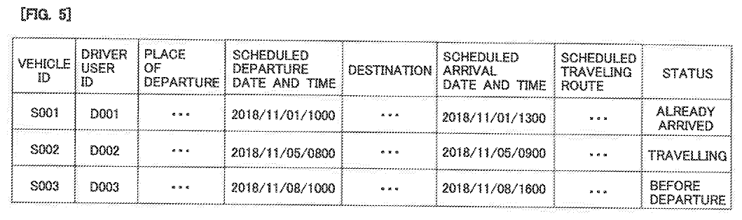

The traveling schedule management database D310 stores a traveling schedule of each vehicle 10, where identification information of a driver user of the vehicle 10 is associated with a traveling schedule of the vehicle 10. Here, a configuration example of traveling schedule information stored in the traveling schedule management database D310 will be described based on FIG. 5. FIG. 5 is a diagram illustrating a table configuration of traveling schedule information. Note that information registered in the traveling schedule information table is not, limited to the example shown in FIG. 5, but fields may be added, changed or deleted as appropriate.

The traveling schedule information table shown in FIG. 5 includes fields such as a vehicle ID, a driver user ID, a place of departure, a scheduled date and time of departure, a destination, a scheduled date and time of arrival, a scheduled traveling route, and a status. A vehicle ID which is information for identifying each vehicle 10 available for ride sharing is registered in the vehicle ID field. The vehicle ID referred to here is information assigned together with a user ID which will be described later when a driver user of each vehicle 10 applies for membership registration for a ride-sharing service, and is information for identifying each vehicle 10. A certain user ID which is information for identifying a driver user of each vehicle 10 available for ride sharing is registered in the driver user ID field. The user ID is information assigned when a driver user of the vehicle 10 available for ride sharing applies for membership registration for a ride-sharing service. Information indicating a place of departure of the vehicle 10 available to each driver user fbr ride sharing is registered in the place of departure field. Note that the place of departure referred to here is not limited to a place where the driver user starts traveling in the vehicle 10, but can be changed by the driver user according to his/her convenience as appropriate. Information indicating a scheduled date and time of departure at which the driver user leaves the above place of departure in the vehicle 10 driven by the driver user is registered in the scheduled date and time of departure field. Information indicating a destination for which the driver user is heading in the vehicle 10 available for ride sharing is registered in the destination field. Note that the destination referred to here is not limited to a place where the driver user's traveling in the vehicle 10 ends, but can be changed according to the convenience of the driver user as appropriate. Information indicating a scheduled date and time at which the driver user traveling in the vehicle 10 driven by the driver user arrives at the above destination is registered in the scheduled date and time of arrival field. Information indicating a route through which the vehicle 10 can pass from the place of departure to the destination of the driver user is registered in the scheduled traveling route field, the route being predicted to allow the driver user to arrive at the destination by the scheduled arrival date and time, Information indicating a traveling situation of the vehicle 10 driven by the driver user is registered in the status field. For example, the status is registered as “already arrived” when the vehicle 10 driven by the driver user has already arrived at the destination, and the status is registered as “traveling” when the vehicle 10 driven by the driver user is traveling from the place of departure to the destination, and the status is registered as “before departure” when the vehicle 10 driven by the driver user has not departed from the place of departure yet. Note that for the vehicle 10 registered as “traveling” in the above status field, information relating to the current position of the vehicle 10 may also be registered in the status field. A current position of the vehicle 10 in that case may he acquired by the server apparatus 300 through communication with the user terminal 200 of the driver user or may be acquired by the server apparatus 300 through communication with a device mounted on the vehicle 10 enabled to communicate.

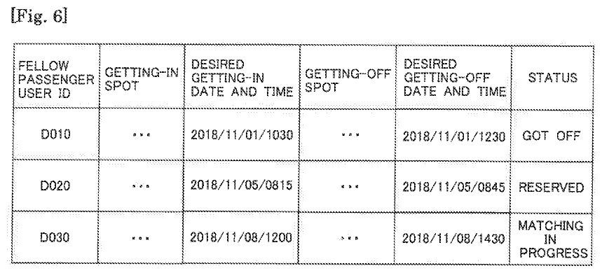

The movement schedule management database D320 stores a movement schedule of a fellow passenger user who wants ride sharing of an arbitrary vehicle 10, where identification information of the fellow passenger user is associated with the movement schedule. Here, one configuration example of the movement schedule information stored in the movement schedule management database D320 will be described based on FIG. 6. FIG. 6 is a diagram illustrating a table configuration of the movement schedule information. Note that the information registered in the movement schedule information table is not limited to the example shown in FIG. 6, but fields can be added, changed or deleted as appropriate.

The movement schedule information table shown in FIG. 6 includes fields such as a fellow passenger user ID, a getting-in spot, a desired getting-in date and time, a getting-off spot, a desired getting-off date and time and a status. A user ID for identifying each fellow passenger user is registered in the fellow passenger user ID field. The user ID of the fellow passenger user is information assigned when the fellow passenger user applies for membership registration for a ride-sharing service as in the case of the aforementioned driver user ID. Information indicating a place where each fellow passenger user wants to ride in the vehicle 10 available for ride sharing is registered in the getting-in spot field. Information indicating a date and time on which each fellow passenger user wants to get in the vehicle 10 available for ride sharing at the above-described, getting-in spot is registered in the desired getting-in date and time field. Information indicating a place where each fellow passenger user wants to get off the vehicle 10 available for ride sharing is registered in the getting-off spot field. Information indicating a date and time on which each fellow passenger user wants to get off the vehicle 10 available for ride sharing at the above-described getting-off spot is registered in the desired getting-off date and time field. Information indicating a traveling situation of the fellow passenger user is registered in the status field. For example, the status is registered as “already got off” when the fellow passenger user has already gotten off the vehicle 10 available for ride sharing, the status is registered as “reserved” when a driver user to be combined with a fellow passenger user is confirmed but the fellow passenger user has not yet got on the vehicle 10 driven by the driver user, and the status is registered as “matching in progress” when a driver user to be combined with a fellow passenger user is not confirmed yet.

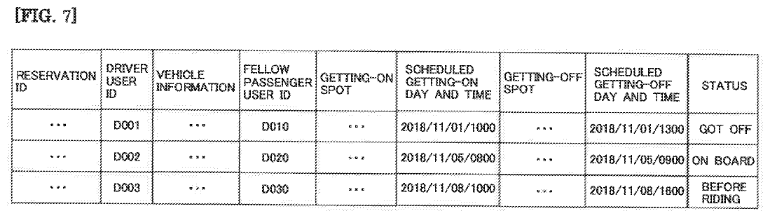

The reservation management database D330 stores reservation information for a ride-sharing service, where information relating to the driver user is associated with information relating to a fellow passenger user scheduled to share the vehicle 10 driven by the driver user. Here, one configuration example of reservation information stored in the reservation management database D330 will be described based on FIG. 7. FIG. 7 is a diagram illustrating a table configuration of reservation information. Note that information registered in the reservation information table is not limited to the example shown in FIG. 7, but fields can be added, changed or deleted as appropriate.

The reservation information table shown in FIG. 7 includes fields such as a reservation ID, a driver user ID, a vehicle information, a fellow passenger user ID, a getting-on spot, a scheduled getting-on date and time, a getting-off spot, a scheduled getting-off date and time and a status. A reservation ID which is information for identifying individual reservation information is registered in the reservation ID field. For example, this reservation ID is used when each user confirms or changes reservation contents. A user ID of a driver user driving the vehicle 10 that is used for ride sharing is registered in the driver user ID field. Information necessary for a fellow passenger user who shares the vehicle 10 to identify the vehicle 10 driven by each driver user is registered in the vehicle information field. For example, information such as vehicle model, automobile registration number (number displayed on the number plate), vehicle body color or the like is registered in the vehicle information field. A user ID of a fellow passenger user scheduled to share the vehicle 10 driven by each driver user is registered in the fellow passenger user ID field. Information indicating a place where a fellow passenger user is allowed to get on the vehicle 10 driven by each driver user (getting-on spot) is registered in the getting-on spot field. Information indicating a scheduled date and time at which a fellow passenger user is allowed to get on the vehicle 10 driven by each driver user at the above getting-on spot is registered in the scheduled getting-on date and time field. Information indicating a place where a fellow passenger user is allowed to get off the vehicle 10 driven by each driver user (getting-off spot) is registered in the getting-off spot field. Information indicating a scheduled date and time at which a fellow passenger user is allowed to get off the vehicle 10 driven by each driver user at the above getting-off spot is registered in the scheduled getting-off date and time field. Information indicating a ride sharing situation of each vehicle 10 is registered in the status field. For example, the status is registered as “already got off” when the fellow passenger user has already got off the vehicle 10 at the above getting-off spot, the status is registered as “getting on” when the fellow passenger user is sharing the vehicle 10 and the status is registered as “before getting on” in a stage before the fellow passenger user gets on the vehicle 10.

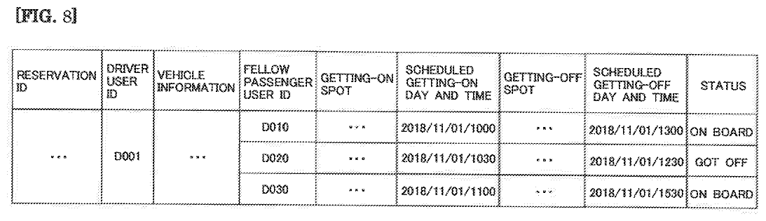

The reservation information table in FIG. 7 corresponds to a table configuration example when one fellow passenger user shares the vehicle 10 driven by each driver user, but the number of fellow passenger users who share the vehicle 10 driven by each driver user may be two or more. In that case, as shown in FIG. 8, one driver user ID may be associated with information of a plurality of fellow passenger users.

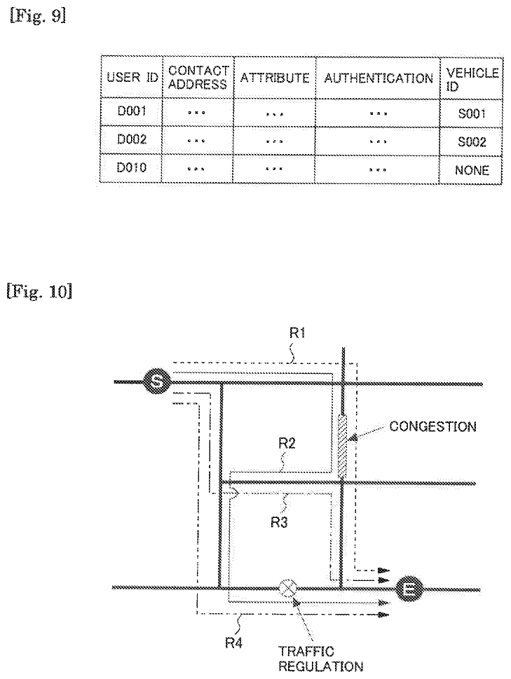

The member information management database D340 stores information on users registered as members in the ride-sharing service (member information). Here, one configuration example of member information stored in the member information management database D340 will be described based on FIG. 9. FIG. 9 is a diagram illustrating a table configuration of member information. Note that information registered in the member information table is not limited to the example shown in FIG. 9, but fields can be added, changed or deleted as appropriate.

The member information table shown in FIG. 9 includes fields such as a user ID, a contact address, an attribute, authentication and a vehicle ID. A user ID assigned when each user applies for member registration for a ride-sharing service is registered in the user ID field. Information indicating a contact address of each user (e.g., electronic mail address, telephone number, or the like, including at least an electronic mail address of the user terminal 200 used by each user) is registered in the contact field. Information indicating an attribute of each user (e.g., name, nickname, age, gender, occupation, work place (school), hobby, skill or the like) is registered in the attribute field Information indicating a password or the like necessary for authentication when the aforementioned request information is registered in the server apparatus 300 or when the aforementioned reservation information is confirmed is registered in the authentication field. A vehicle ID of the vehicle 10 available to each user for ride sharing is registered in the vehicle ID field. Note that, for example, “None” is registered in the vehicle ID field for a user not possessing the vehicle 10 available for ride sharing.

Next, the matching processing unit F310 performs a matching process based on request information from a driver user or a fellow passenger user. More specifically, when the server apparatus 300 receives request information transmitted from the user terminal 200 of the driver user, the matching processing unit F310 generates a traveling schedule information table as shown in aforementioned FIG. 5 based on the request information and stores the generated traveling schedule information table in the traveling schedule management database D310. In that case, the information registered in the scheduled traveling route field of the traveling schedule information table is set by a route setting unit F320 which will be described later. Furthermore, when the server apparatus 300 receives request information transmitted from the user terminal 200 of the fellow passenger user, the matching processing unit F310 generates a movement schedule information table as shown in aforementioned FIG. 6 based on the request information and stores the generated movement schedule information table in the movement schedule management database D320. The matching processing unit F310 compares the traveling schedule information table stored in the traveling schedule management database D310 and the movement schedule information table stored in the movement schedule management database D320 and extracts a traveling schedule suitable for a movement schedule of each fellow passenger user. More specifically, the matching processing unit F310 extracts the traveling schedule information table where the getting-in spots registered in the getting-in spot field in the movement schedule information table of the fellow passenger users and the getting-off spots registered in the getting-off spot field in the movement schedule information table are located on the scheduled traveling route registered in the scheduled traveling route field. Next, the matching processing unit F310 provisionally combines the driver user associated with the extracted traveling schedule information table with the fellow passenger users. When the provisional combination of the driver user and the fellow passenger users is determined in such a procedure, the matching processing unit F310 transmits information indicating ride sharing conditions (e.g., getting-in spots of the fellow passenger users, scheduled getting-in dates and times of the fellow passenger users, getting-off spots of the fellow passenger users, scheduled getting-off dates and times of the fellow passenger users, scheduled traveling route, type of the vehicle 10) to the respective user terminals 200A and 200B of the driver user and the fellow passenger users in the above-described provisional combination. In response to this, when information accepting the above ride sharing conditions are sent back from both user terminals 200 of the driver user and the fellow passenger user, the matching processing unit F310 confirms the above provisional combination as an official combination. Accordingly, the matching processing unit F310 generates a reservation information table as shown in aforementioned FIGS. 7 and 8 based on the above official combination, and stores the generated reservation information table in the reservation management database D330.

The route setting unit F320 extracts all routes connecting places of departure and destinations included in request information when the server apparatus 300 receives the request information from each driver user, the routes through which the vehicle 10 can pass. Next, the route setting unit F320 sets a route predicted to allow the driver user to arrive at the above-described destination by the scheduled arrival date and time included in the above-described request information among the extracted routes as the aforementioned scheduled traveling route. In that case, the route setting unit F320 may also set the scheduled traveling route by taking into account congestion prediction information and traffic regulation information or the like in the time zone in which the driver user moves from the place of departure to the destination.

Here, an example of the method of setting the scheduled traveling route will be described based on FIG. 10. FIG. 10 is a diagram illustrating routes when the driver user moves from a place of departure S to a destination E using the vehicle 10 driven by the driver user himself/herself. In the example illustrated in FIG. 9, the vehicle 10 can select a route R1 (route illustrated by a broken line in FIG. 10), a route R2 (route illustrated by a solid line in FIG. 10), a route R3 (route illustrated by a single-dot dashed line in FIG. 10) and a route R4 (route illustrated by a two-dot dashed line in FIG. 10) as the route along which the vehicle 10 moves from the place of departure S to the destination E. However, since the route R2 among the routes R1 to R4 has a greater traveling distance than the other routes R1, R3 and R4, the driver user will not be able to arrive at the destination by the scheduled arrival date and time. Therefore, the route R2 is excluded from among candidates for the scheduled traveling route. Of the remaining three routes R1, R3 and R4, the route R1 passes through a section where congestion is predicted in the time zone in which the driver user moves from the place of departure S to the destination E, and so the driver user will not be able to arrive at the destination by the scheduled arrival date and time. Of the three routes R1, R3 and R4, the route R4 passes through a section which is subjected to traffic regulation in the time zone in which the driver user moves from the place of departure S to the destination E, and so the driver user will not be able to arrive at the destination by the scheduled arrival date and time. Therefore, solely the route R3 among the three routes R1, R3 and R4 is the route predicted to allow the driver user to arrive at the destination by the scheduled arrival date and time. Therefore, in the example illustrated in FIG. 10, the route R3 is set as the scheduled traveling route. Accordingly, the matching processing unit F310 provisionally combines fellow passenger users whose getting-in spots and getting-off spots are located on the route R3 in FIG. 10 with the driver user. When ride sharing with such a combination of users, it is possible to prevent the driver user from arriving at the destination later than the scheduled arrival date and time

Note that there may also be a case where not solely the route R1 but also the route R2 includes a section where congestion is predicted in the time zone in which the driver user moves from the place of departure S to the destination E. In such a case, one of the route R1 and the route R2 which is predicted to allow the driver user to arrive at the destination earlier may be set as the scheduled traveling route. In that case, it is possible to reduce, as much as possible, the delay when the driver user arrives at the destination.

When there are a plurality of routes predicted to allow the driver user to arrive at the destination by the scheduled arrival date and time, the route predicted to allow the driver to arrive at the destination earliest may also be set as the scheduled traveling route. As another method, a plurality of routes predicted to allow the driver user to arrive at the destination by the scheduled arrival date and time may be registered in the scheduled traveling route field in the above-described traveling schedule information table. The matching processing unit F310 may also set a route going through a getting-in spot and a destination of a fellow passenger user among the plurality of routes registered in the scheduled traveling route field as the official scheduled traveling route.

### System Operation

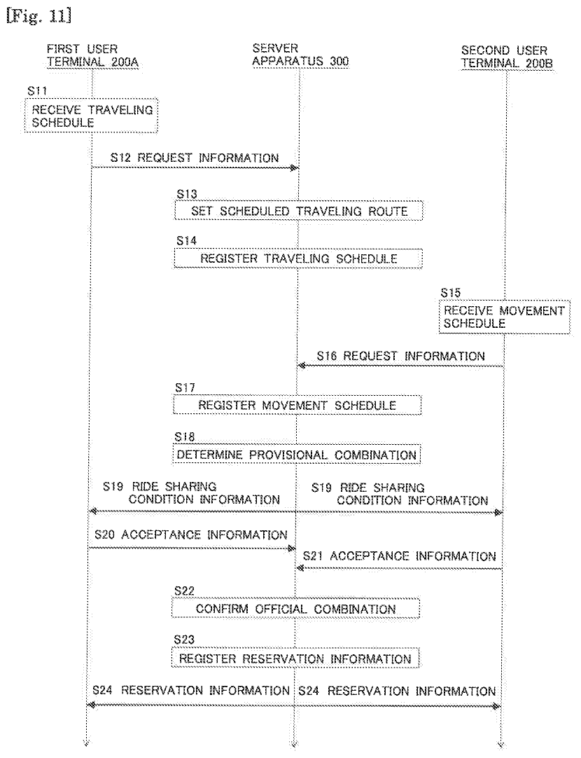

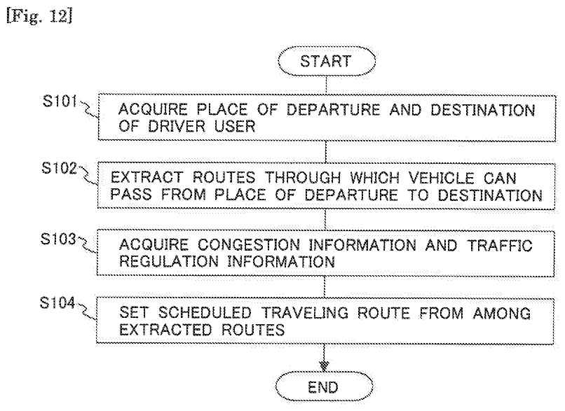

An operation flow of the ride sharing system according to the present embodiment will be described. FIG. 11 is a diagram illustrating the operation flow of the ride sharing system according to the present embodiment. FIG. 11 is a flowchart illustrating an overview of a flow of data transmitted/received among the respective components in ride sharing and a processing flow carried out in each component.

In FIG. 11, when the first user terminal 200A receives input of a traveling schedule to the input unit 205 by the driver user (S11), the first user terminal 200A transmits the traveling schedule from the communication unit 207 to the server apparatus 300 as request information (S12).

When the communication unit 304 of the server apparatus 300 receives the request information from the first user terminal 200A, the route setting unit F320 sets a scheduled traveling route based on the request information (S13). The process of setting the scheduled traveling route is performed based on a processing flow as illustrated in FIG. 12.

In FIG. 12, the route setting unit F320 acquires the place of departure and the destination of the driver user from the request information received from the first user terminal 200A (S101). Next, the route setting unit F320 extracts all the routes acquired in S101 through which the vehicle 10 can pass from the place of departure to the destination (S102). The route setting unit F320 acquires congestion prediction information and traffic regulation information in the time zone in which the driver user moves from the place of departure to the destination based on the scheduled departure date and time and the scheduled arrival date and time included in the request information received from the first user terminal 200A (S103). For example, the route setting unit F320 may acquire congestion prediction information or traffic regulation information of each route extracted in S102 using road traffic information communication system (Vehicle Information and Communication System: VICS (registered trademark)) or may acquire congestion prediction information or traffic regulation information of each route extracted in S102 using probe traffic information generated based on positions other vehicle have actually traveled or vehicle speeds. The route setting unit F320 extracts a route predicted to allow the driver user to arrive at the destination by the scheduled arrival date and time and sets the extracted route as the scheduled traveling route in consideration of the congestion prediction information or the traffic regulation information acquired in S103 among the routes extracted in S102 using the aforementioned method described in FIG. 10 (S104).

Returning to FIG. 11 here, the matching processing unit F310 of the server apparatus 300 generates a traveling schedule information table as illustrated in aforementioned FIG. 5 based on the request information received by the server apparatus 300 in S12 and the scheduled traveling route set by the route setting unit F320 in S13 and registers the generated traveling schedule information table in the traveling schedule management database D310 (S14).

Upon receiving the input of the movement schedule to the input unit 205 by the fellow passenger user (S15), the second user terminal 200B transmits the movement schedule from the communication unit 207 to the server apparatus 300 as request information (S16).

When the communication unit 304 of the server apparatus 300 receives the request information from the second user terminal 200B, the matching processing unit F310 generates a movement schedule information table as shown in aforementioned FIG. 6 based on the request information and registers the generated movement schedule information table in the movement schedule management database D320 (S17).

Note that the method for each user to have the above request information registered in the server apparatus 300 is not limited to the method using the user terminals 200A, 200B. For example, the above request information may also be registered in the server apparatus 300 using an arbitrary terminal connectable to the network N1 (smartphone, mobile phone, tablet terminal, personal information terminal, wearable computer or the like) or a personal computer (PC). Furthermore, in the example shown in FIG. 11, the request information from the first user terminal 200A is transmitted to the server apparatus 300 earlier than the request information from the second user terminal 200B, but the request information from the second user terminal 200B may also be transmitted to the server apparatus 300 earlier than the request information from the first user terminal 200A.

The matching processing unit F310 of the server apparatus 300 compares the traveling schedule information table stored in the traveling schedule management database D310 with the movement schedule information table stored in the movement schedule management database D320 and extracts a traveling schedule that matches the movement schedule of each fellow passenger user. More specifically, as described above, the matching processing unit F310 extracts the traveling schedule information table in which the scheduled traveling route going through the getting-in spot and the getting-off spot of each fellow passenger user is registered in the scheduled traveling route field. Next, the matching processing unit F310 provisionally combines the driver user associated with the extracted traveling schedule information table with the fellow passenger user (S18).

The matching processing unit F310 transmits information indicating ride sharing conditions (getting-in spots of the fellow passenger users, scheduled getting-in dates and times of the fellow passenger users, getting-off spots of the fellow passenger users, scheduled getting-off dates and times of the fellow passenger users, type of vehicle 10 or the like) to the respective user terminals 200A and 200B of the driver user and the fellow passenger users included in the provisional combination determined in S18 from the communication unit 304 (S19).

When the first user terminal 200A and the second user terminal 200B receive information indicating the ride sharing condition, the respective user terminals 200A and 200B display information indicating the ride sharing condition in the above-described provisional combination on the display unit 204. In that case, the respective user terminals 200A and 200B perform a process of urging each user to select whether or not to accept the information indicating the ride sharing condition (e.g., a process of causing the input unit 205 to display a button to select whether or not to accept the ride sharing condition on a touch panel or the like). When each user selects to accept the information indicating the ride sharing condition, each user terminal 200A or 200B transmits information indicating acceptance of the ride sharing condition in the above-described provisional combination (acceptance information) from the communication unit 207 to the server apparatus 300 (S20, S21). Note that in the example shown in FIG. 11, the acceptance information from the first user terminal 200A is transmitted to the server apparatus 300 earlier than the acceptance information from the second user terminal 200B, but the acceptance information from the second user terminal 200B can be transmitted earlier than the acceptance information from the first user terminal 200A.

When the communication unit 304 of the server apparatus 300 receives the acceptance information which is information indicating acceptance of the ride sharing condition in the above-described provisional combination, the matching processing unit F310 confirms the above-described provisional combination as an official combination (S22). The matching processing unit F310 generates the reservation information tables as shown in aforementioned FIGS. 7 and 8 based on the ride sharing condition in the official combination and registers the generated reservation information table in the reservation management database D330 (S23). The matching processing unit F310 transmits the information (reservation information) included in the generated reservation information table to the first user terminal 200A and the second user terminal 200B (S24).

Note that when neither the first user terminal 200A nor the second user terminal 200B can receive the above-described acceptance information, the matching processing unit F310 of the server apparatus 300 is assumed to reset a new provisional combination made up of a user combination different from the above-described provisional combination.

According to the aforementioned flow, since a route that allows the driver user to arrive at the destination by the scheduled arrival date and time is set as the scheduled traveling route and fellow passenger users whose getting-in spots and getting-off spots are located on the scheduled traveling route are combined with the driver user, it is possible to reduce, as much as possible, the likelihood that the driver user will be unable to arrive at the destination by the scheduled arrival date and time caused by the vehicle driven by the driver user having to go through the getting-in spots and the getting-off spots of the fellow passenger users. As a result, it is possible to reduce, as much as possible, the likelihood that the driver user may arrive at the destination later than the scheduled arrival date and time.

### Others

Note that the above embodiments are merely examples and the present disclosure can be changed and implemented as appropriate without departing from the spirit and scope of range of the present disclosure.

The processes and means described in the present disclosure may be freely combined and implemented unless there are technical inconsistencies. A process described as being performed by one device may be shared and executed among a plurality of devices. Alternatively processes described as being executed by different devices may be executed by one device. In a computer system, it is possible to flexibly change a hardware configuration used to implement each function.

Furthermore, the present disclosure can also be implemented by supplying a computer program including the functions described in the above embodiments to a computer and by one or more processors included in the computer reading and executing the program. Such a computer program may be supplied to the computer through a non-transitory computer readable storage medium which is connectable to a system bus of the computer or may be supplied to the computer via a network. The non-transitory computer readable storage medium is a storage medium which allows information such as data or a program to be stored through electrical, magnetic, optical, mechanical or chemical action and read from the computer or the like, and examples of such a medium include any type of disk such as magnetic disk (floppy (registered trademark) disk, hard disk drive (HDD) or the like), optical disk (CD-ROM, DVD disk, blue-ray disk or the like), read-only memory (ROM), random access memory (RAM), EPROM, EEPROM, magnetic card, flash memory, optical card and SSD (Solid State Drive).

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An information processing apparatus in a mode in which a plurality of users share a same vehicle, that determines a combination between a driver user who is a user driving the vehicle and fellow passenger users who are users riding in the vehicle, the information processing apparatus comprising a controller including at least one processor,
the controller configured to execute:
setting, as a scheduled traveling route, a route through which the vehicle driven by the driver user can pass from a place of departure to a destination of the driver user, the route being predicted to allow the driver user to arrive at the destination by a date and time desired by the driver user; and
combining the driver user and a fellow passenger user whose getting-in spot which is a desired place of getting in the vehicle and whose getting-off spot which is a desired place of getting off the vehicle are located on the scheduled traveling route among fellow passenger users desiring to ride in the vehicle.

2. The information processing apparatus according to claim 1, wherein the controller sets the scheduled traveling route based on congestion prediction information and/or traffic regulation information in a time zone in which the driver user moves from the place of departure to the destination.

3. An information processing method for determining a combination between a driver user who is a user driving a vehicle and fellow passenger users who are users riding in the vehicle in a mode in which a plurality of users ride in a same vehicle, the information processing method causing a computer to execute:
a step of setting, as a scheduled traveling route, a route through which the vehicle driven by the driver user can pass from a place of departure to a destination of the driver user, the route being predicted to allow the driver user to arrive at the destination by a date and time desired by the driver user; and
a step of combining the driver user and a fellow passenger user whose getting-in spot which is a desired place of getting in the vehicle and whose getting-off spot which is a desired place of getting off the vehicle are located on the scheduled traveling route among fellow passenger users desiring to ride in the vehicle.

4. A non-transitory storage medium that stores an information processing program for determining a combination between a driver user who is a user driving a vehicle and fellow passenger users who are users riding in the vehicle in a mode in which a plurality of users ride in a same vehicle, the information processing program causing a computer to execute:
a step of setting, as a scheduled traveling route, a route through which the vehicle driven by the driver user can pass from a place of departure to a destination of the driver user, the route being predicted to allow the driver user to arrive at the destination by a date and time desired by the driver user; and
a step of combining the driver user and a fellow passenger user whose getting-in spot which is a desired place of getting in the vehicle and whose getting-off spot which is a desired place of getting off the vehicle are located on the scheduled traveling route among fellow passenger users desiring to ride in the vehicle.
